(19) United States
(12) Patent Application Publication
(10) Pub. No.: US 2026/0365128 A1
(43) Pub. Date: Nov. 19, 2026

(54) POWER SUPPLY SYSTEM

(71) Applicant: Yazaki Corporation, Tokyo (JP)

(72) Inventors: Motoki SHIMIZU, Makinohara-shi (JP); Sadaharu OKUDA, Makinohara-shi (JP); Ryo HIRAMATSU, Makinohara-shi (JP); Kenji KAZUMI, Makinohara-shi (JP)

(73) Assignee: Yazaki Corporation, Tokyo (JP)

(21) Appl. No.: 19/642,714

(22) Filed: Apr. 9, 2026

(30) Foreign Application Priority Data
May 14, 2025 (JP) 2025-080971

(51) Int. Cl. B60R 16/023; B60L 50/60; B60R 16/033; H02J 1/08; H02J 1/082

(52) U.S. Cl. CPC B60R 16/0231; B60L 50/60; B60R 16/033; H02J 1/082; H02J 1/084

(57) ABSTRACT

A power supply system includes a first/second power supply line supplying a first/second load driven with power of a first/second voltage value; a power supply source supplying power of a third voltage value different from the first and second voltage values; a first power converter converting the power of the third voltage value to the power of the first voltage value to supply it to the first power supply line; a second power converter converting the power of the third voltage value to the power of the second voltage value to supply it to the second power supply line; a first battery supplying the power of the first voltage value to the first power supply line; and a third power supply converter converting the power of the first volage value to the power of the second voltage value to supply it to the second power supply line.

### TECHNICAL FIELD

The present invention relates to a power supply system.

### BACKGROUND ART

Conventionally, vehicles are equipped with an auxiliary battery to suppress power supply fluctuations to the load and to supply dark current. Electric vehicles are equipped with a high-voltage battery to drive the motor. Therefore, power supply systems that do not include the auxiliary battery have been proposed (for example, see Patent Document 1).

### CITATION LIST

### Patent Documents

[Patent Document 1] JP 2019-162014A

### SUMMARY OF THE INVENTION

### Technical Problem

However, the technology disclosed in Patent Document 1 has poor efficiency in power conversion from high voltage to low voltage when supplying dark current, and may not be able to handle increased power consumption or fluctuations in the power supply to the load. Furthermore, in recent years, vehicles have begun to be equipped with accessories that operate at 48V in addition to accessories that operate at 12V.

Therefore, an object of the present invention is to provide a low-cost multiple-voltage power supply system.

### Solution to Problem

In order to solve the above-mentioned technical problem, a power supply system according to an embodiment of the present invention includes a first power supply line configured to supply a first load that is driven by power of a first voltage value with the power of the first voltage value; a second power supply line configured to supply a second load that is driven by power of a second voltage value different from the first voltage value with the power of the second voltage value; a power supply source configured to supply power of a third voltage value different from the first voltage value and the second voltage value; a first power converter configured to convert the power of the third voltage value that is supplied by the power supply source to the power of the first voltage value to supply such first power to the first power supply line; a second power converter configured to convert the power of the third voltage value that is supplied by the power supply source to the power of the second voltage value to supply such second power to the second power supply line; a first battery configured to supply the power of the first voltage value to the first power supply line; and a third power supply converter configured to convert the power of the first volage value that is supplied to the first power supply line to the power of the second voltage value to supply such power of the second voltage value to the second power supply line.

### Effect of the Invention

According to the present invention, it is possible to provide a low-cost multiple-voltage power supply system.

### BRIEF DESCRIPTION OF THE DRAWINGS

FIG. 1 is a view showing a power supply system 100 according to an embodiment of the present invention.

FIG. 2 is a view describing a flow of power when the vehicle is operating (for example, a period when an ignition power supply of the vehicle is on).

FIG. 3 is a view describing a flow of power when the vehicle is stopped (for example, a period when an ignition power supply of the vehicle is off).

FIG. 4 is a view showing another example of the power supply system 100.

FIG. 5 is a view showing an example of a configuration of a third power converter 107.

FIG. 6 is a view showing another example of the power supply system 100.

FIG. 7 is a view describing a flow of power from a first external power supply 400 connected to a first relief terminal 111.

FIG. 8 is a view describing a flow of power from a second external power supply 500 connected to a second relief terminal 112.

### DESCRIPTION OF EMBODIMENTS

### Power supply system 100

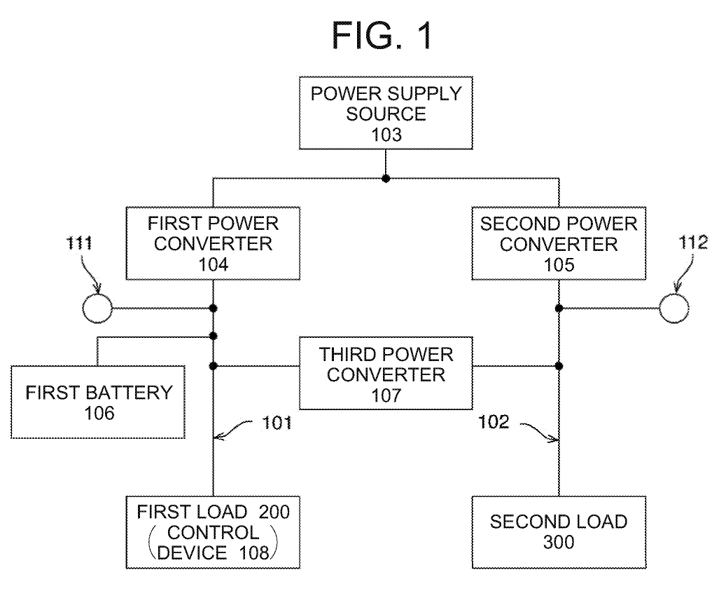

FIG. 1 is a view showing a power supply system 100 according to an embodiment of the present invention. The power supply system 100 supplies power to a first load 200 driven by power of a first voltage value and a second load 300 driven by power of a second voltage value. The second voltage value is a voltage value different from the first voltage value, for example, smaller than the first voltage value. The power supply system 100 is, for example, a power supply system mounted on a vehicle, and the first load and the second load include, for example, a control device (Electronic Control Unit, ECU) mounted on the vehicle. The first voltage value is, for example, 48V, and the second voltage value is, for example, 12V.

The power supply system 100 has a first power supply line 101, a second power supply line 102, a power supply source 103, a first power converter 104, a second power converter 105, a first battery 106, a third power converter 107, and a control device 108.

The first power supply line 101 is connected to the first load 200 and supplies power of the first voltage value to the first load 200.

The second power supply line 102 is connected to the second load 300 and supplies power of the second voltage value to the second load 300.

The power supply source 103 supplies power of a third voltage value. The power supply source 103 is, for example, a generator or a high-voltage battery (for example, a lithium-ion battery). The third voltage value is different from the first voltage value and the second voltage value, and is, for example, greater than the first voltage value and the second voltage value. The third voltage value is, for example, 60V or more, for example, 400V or 800V.

The first power converter 104 is connected between the first power supply line 101 and the power supply source 103, and is configured to convert the power of the third voltage value from the power supply source 103 into power of the first voltage value, and to supply the power of the first voltage value to the first power supply line 101. The first power converter 104 includes, for example, a DC/DC converter.

The second power converter 105 is connected between the second power supply line 102 and the power supply source 103, and is configured to convert the power of the third voltage value from the power supply source 103 into power of the second voltage value, and to supply the power of the second voltage value to the second power supply line 102. The second power converter 105 includes, for example, a DC/DC converter.

The first battery 106 supplies the power of the first voltage value to the first power supply line 101. The first battery 106 is, for example, a storage battery (for example, a lithium ion battery) and is configured to charge and discharge the power of the first voltage value. That is, the first battery 106 not only supplies the power of the first voltage value to the first power supply line 101, but also receives the power of the first voltage value from the first power supply line 101.

The third power converter 107 converts the power of the first voltage value supplied to the first power supply line 101 into the power of the second voltage value, and supplies the power of the second voltage value to the second power supply line 102. The third power converter 107 includes, for example, a DC/DC converter.

The control device 108 controls initiating and stopping of the vehicle and starting and stopping of the first power converter 104, the second power converter 105, and the third power converter 107. The control device 108 controls initiating and stopping of the vehicle based on, for example, a user input (for example, via a user key device).

The control device 108 is a load that is driven by the power of the first voltage value, and is driven by the power supplied from the first power supply line 101, then the first load 200 includes the control device 108. That is, the control device 108 is driven by the power supplied from the first power supply line 101.

In the present embodiment, the control device 108 controls the first power converter 104 and the second power converter 105 to operate and controls the third power converter 107 to stop during the period when the vehicle is operating, and controls the first power converter 104 and the second power converter 105 to stop and controls the third power converter 107 to operate during the period when the vehicle is stopped.

At this time, the control device 108 determines that the vehicle is operating, for example, when power is supplied to a prime mover (for example, an engine or a motor) of the vehicle and the prime mover of the vehicle is in an operable state (for example, when the ignition power supply of the vehicle is turned on), and determines that the vehicle is stopped when power is not supplied to the prime mover of the vehicle and the prime mover of the vehicle is in an inoperable state (for example, when the ignition power supply of the vehicle is turned off). That is, the control device 108, for example, initiates the vehicle, the first power converter 104, and the second power converter 105 and stops the third power converter 107 when the ignition power supply of the vehicle changes from off to on, and stops the vehicle, the first power converter 104, and the second power converter 105 and starts the third power converter 107 when the ignition power supply of the vehicle changes from on to off.

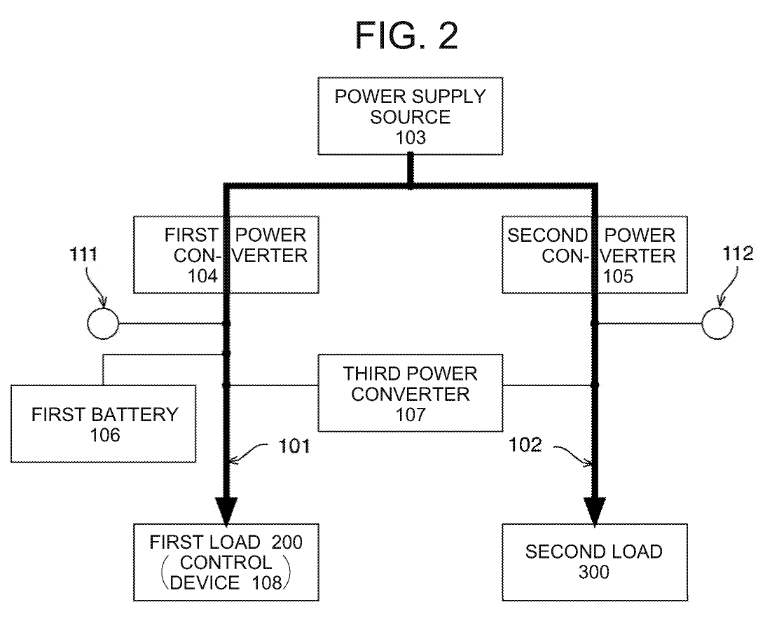

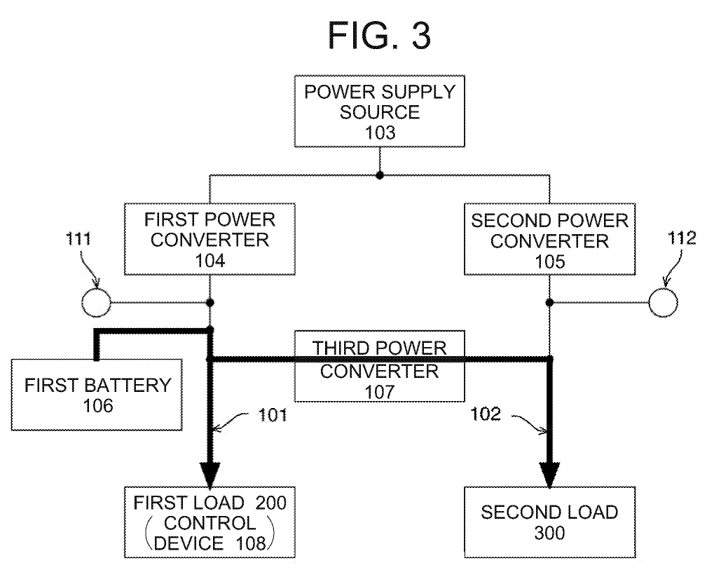

Therefore, according to the present embodiment, while the vehicle is operating (for example, during the period when the ignition power supply of the vehicle is turned on), the power from the power supply source 103 is supplied to the first load 200 and the second load 300 via the first power converter 104 and the second power converter 105, as shown in FIG. 2. Then, during the period when the vehicle is stopped (for example, during the period when the ignition power supply of the vehicle is turned off), the power from the first battery 106 is supplied to the first load 200, and is also supplied to the second load 300 via the third power converter 107, as shown in FIG. 3. Therefore, according to the present embodiment, even if the vehicle does not have a battery for supplying power of the second voltage value to the second load 300, it is possible to supply power to the second load 300 while the vehicle is stopped. As a result, according to the present embodiment, it is possible to provide a low-cost multi-voltage power supply system. Furthermore, according to the present embodiment, it is possible to supply power from the first battery 106 to the first load 200 when an instantaneous current is required.

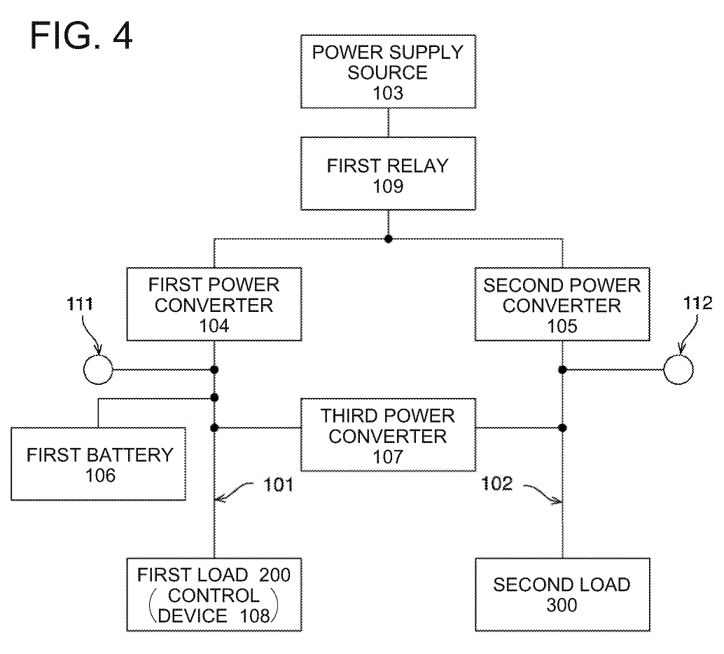

As shown in FIG. 4, the power supply system 100 may further include a first relay 109. The first relay 109 is connected between the power supply source 103, and the first converter 104 and the second power converter 105. The control device 108, during the period when the vehicle is operating, may control the first relay 109 to be on to supply power of the third voltage value to the first power converter 104 and the second power converter 105 so as to operate the first power converter 104 and the second power converter 105, and during the period when the vehicle is stopped, it may control the first relay 109 to be off to cut off the supply of power of the third voltage value to the first power converter 104 and the second power converter 105 so as to stop the first power converter 104 and the second power converter 105. That is, the control device 108 may, for example, control the first relay 109 to turn on when the vehicle ignition power supply is changed from off to on, and control the first relay 109 to turn on when the vehicle ignition power supply is changed from on to off.

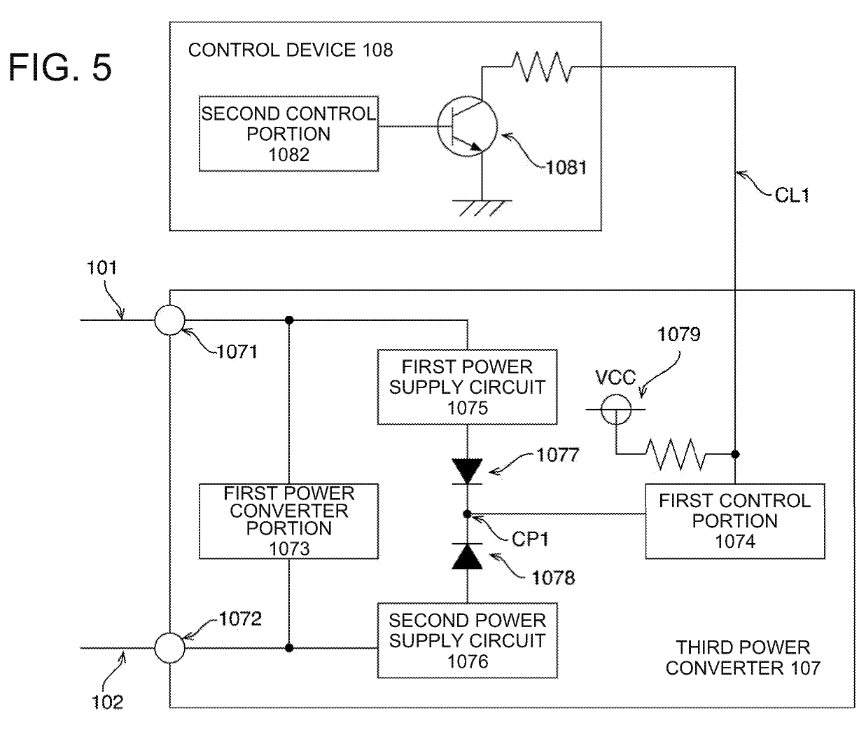

FIG. 5 is a view showing an example of the third power converter 107. In the example shown in FIG. 5, the third power converter 107 has a first terminal 1071, a second terminal 1072, a first power conversion portion 1073, a first control portion 1074, and a first power supply circuit 1075.

The first terminal 1071 is a terminal connected to the first power supply line 101, and the second terminal 1072 is a terminal connected to the second power supply line 102.

The first power converter portion 1073 is connected between the first terminal 1071 and the second terminal 1072 to convert the power of the first voltage value supplied to the first power supply line 101 into power of the second voltage value so as to supply to the second power supply line 102.

The first control portion 1074 controls the initiating and stopping of the first power converter portion 1073. The first control portion 1074 is connected to the control device 108 to control the initiating and stopping of the first power converter portion 1073 based on a control signal from the control device 108.

The first power supply circuit 1075 is connected between the first terminal 1071 and the first control portion 1074 to convert the power of the first voltage value supplied from the first power supply line 101 into power of a fourth voltage value so as to supply the power of the fourth voltage value to the first control portion 1074.

In this manner, even when the vehicle is stopped, it becomes possible to supply the power from the first battery 106 to the first control portion 1074, that is, the third power converter 107, via the first power supply line 101. As a result, it becomes possible to control the operation of the third power converter 107 even when the vehicle is stopped.

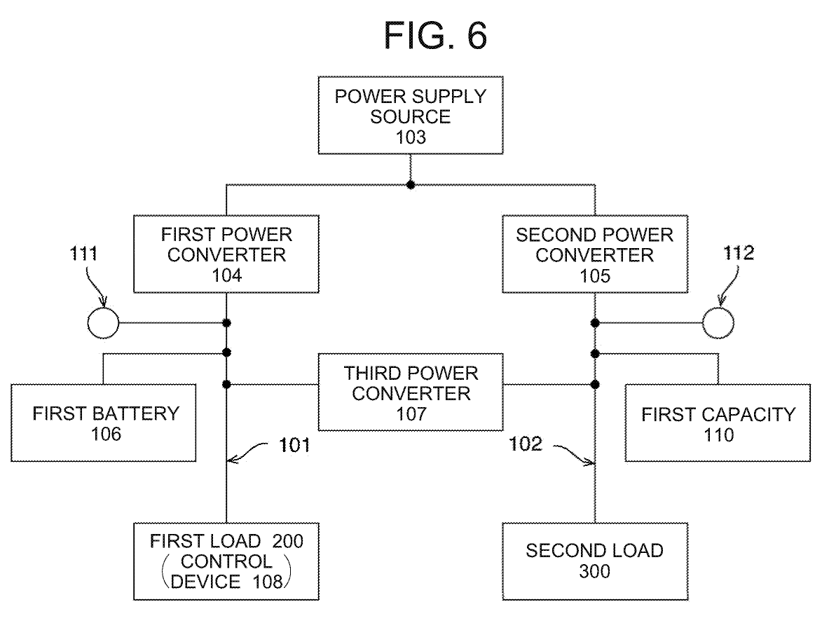

As shown in FIG. 6, the power supply system 100 may further include a first capacitor 110 connected to the second power supply line 102. In this manner, when an instantaneous current is required, it becomes possible to supply power from the first capacitor 110 to the second power supply line.

### First relief terminal 111, second relief terminal 112

If the vehicle is stopped and a state in which the power is not supplied from the power supply source 103 to the first load 200 and the second load 300 continues for a long period of time, the charging power of the first battery 106 may be consumed and there is a case in which the first battery 106 may run out.

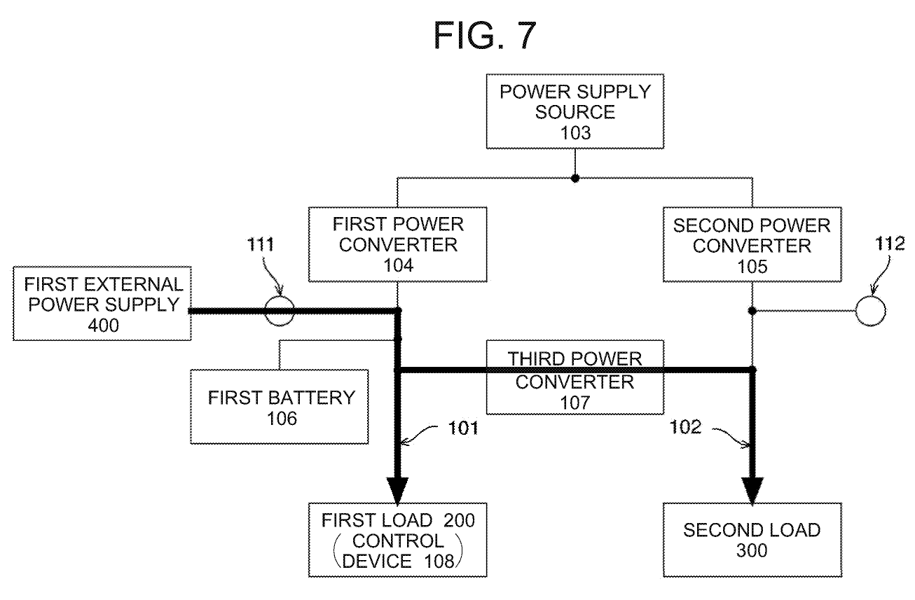

Therefore, it is preferable that the power supply system 100 further includes a first relief terminal 111 as shown in FIG. 1. The first relief terminal 111 is a relief terminal for connecting a first external power supply 400, which supplies power of the first voltage value, to the first power supply line 101. The power from the first external power supply 400 connected to the first relief terminal 111 is supplied to the first load 200 as shown in FIG. 7. Furthermore, the power from the first external power supply 400 is also supplied to the second load 300 via a third power converter 107 as shown in FIG. 7.

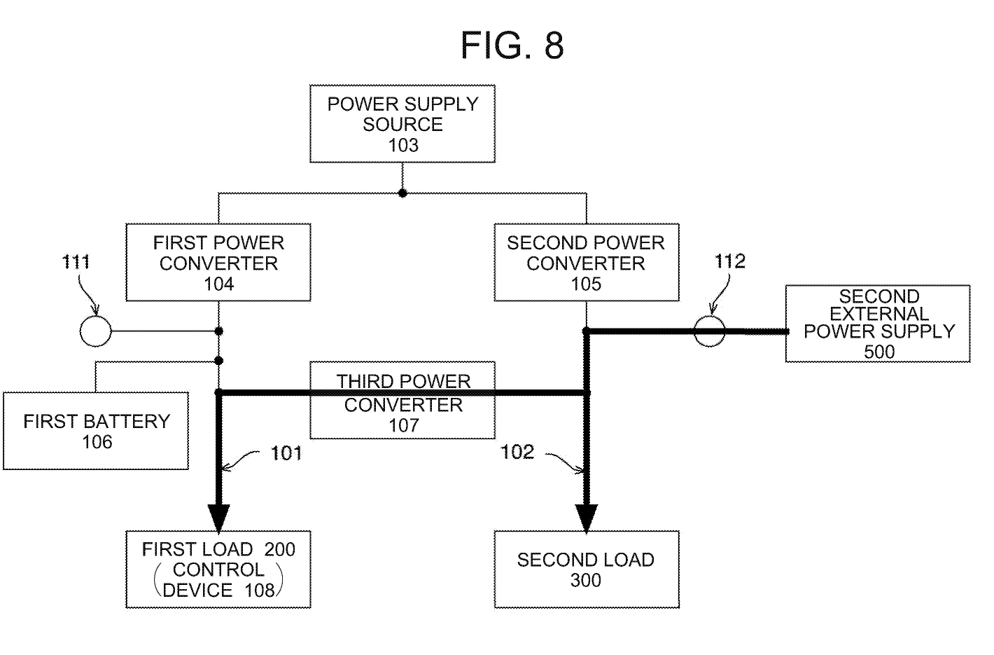

As shown in FIG. 1, the power supply system 100 may further include a second relief terminal 112. The second relief terminal 112 is a relief terminal for connecting a second external power supply 500 that supplies power of the second voltage value to the second power supply line 102. In this case, it is preferable that the third power converter 107 is a bidirectional power converter such that the power can be supplied from the second power supply line 102 to the first power supply line 101 in addition to the power supply from the first power supply line 101 to the second power supply line 102. In this manner, the power from the second external power supply 500 connected to the second relief terminal 112 is converted to the power of the first voltage value by the third power converter 107, and the power of the first voltage value is supplied to the first power supply line 101. As a result, the power from the second external power supply 500 connected to the second relief terminal 112 is supplied to the first load 200 and the second load 300, as shown in FIG. 8.

In this case, it is preferable that the third power converter 107 further includes a second power supply circuit 1076 as shown in FIG. 5.

The second power supply circuit 1076 is connected between the second terminal 1072 and the first control portion 1074 to convert the power of the second voltage value supplied from the second power supply line 102 into power of a fourth voltage value so as to supply the power of the fourth voltage value to the first control portion 1074.

In this manner, even if the first battery 106 runs out while the vehicle is stopped, it is possible to supply the power from the second external power supply 500 to the first control portion 1074, that is, the third power converter 107, via the second power supply line 102. As a result, it is possible to control the operation of the third power converter 107 even if the first battery 106 runs out while the vehicle is stopped.

As shown in FIG. 5, the second power supply circuit 1076 may be connected to a first connection point CP1 between the first control portion 1074 and the first power supply circuit 1075. In this case, the power supply system 100 may further include a first diode 1077 and a second diode 1078. The first diode 1077 is connected between the first power supply circuit 1075 and the first connection point CP1, and a forward direction of the first diode 1077 is from the first power supply circuit 1075 to the first connection point CP1. The second diode 1078 is connected between the second power supply circuit 1076 and the first connection point CP1, and a forward direction of the second diode 1078 is from the second power supply circuit 1076 to the first connection point CP1.

For example, the third power converter 107 may be configured not to operate when a stop command is received from the control device 108, but to operate when a stop command is not received from the control device 108. In this manner, even if the first battery 106 runs out while the vehicle is stopped such that there is no power supply from the first battery 106 and the control device 108 cannot operate, it is possible that the third power converter 107 can operate with the power from the second external power source 500 to convert the power of the second voltage value supplied to the second power supply line 102 into power of the first voltage value and supply it to the first power supply line 101.

As shown in FIG. 5, the first control portion 1074 may be connected to the control device 108 via a first communication line CL1, for example, and the control device 108 may include a switching element 1081 (for example, a transistor) and a second control portion 1082, and the third power converter 107 may include a constant voltage source 1079. The switching element 1081 is connected between the first communication line CL1 and ground, the second control portion 1082 is connected to a control terminal of the switching element 1081 to control the on/off of the switching element 1081, and the constant voltage source 1079 is connected to the first communication line CL1 to supply a constant voltage to the first communication line CL1.

Then, the second control portion 1082 may control the switching element 1081 to be on during the period when the vehicle is operating, and may control the switching element 1081 to be off during the period when the vehicle is stopped. In this manner, when the switching element 1081 is on, that is, during the period when the vehicle is operating, the voltage of the first communication line CL1 becomes the constant voltage supplied by the constant voltage source 1079, and this constant voltage is input as a stop signal to the third power converter 107, and when the switching element 1081 is off, that is, during the period when the vehicle is stopped, the voltage of the first communication line CL1 becomes 0V, and there is no stop signal input to the third power converter 107. As a result, it leads to a case in which the third power converter 107 operates during the period when the vehicle is stopped, and the third power converter 107 stops during the period when the vehicle is operating. Even if in a case in which the first battery 106 runs out while the vehicle is stopped such that there is no power supplied from the first battery 106 and the control device 108 cannot operate, no stop signal is input to the third power converter 107 such that the third power converter 107 still operates.

The present invention has been described above in terms of preferred embodiments thereof. While the present invention has been described herein with reference to specific examples, various modifications and variations can be made to these examples without departing from the spirit and scope of the present invention as set forth in the claims.

### REFERENCE SIGNS LIST

100 power supply system
101 first power supply line
102 second power supply line
103 power supply source
104 first power converter
105 second power converter
106 first battery
107 third power converter
1071 first terminal
1072 second terminal
1073 first power converter portion
1074 first control portion
1075 first power supply circuit
1076 second power supply circuit
1077 first diode
1078 second diode
1079 constant voltage source
108 control device
1081 switching element
1082 second control portion
109 first relay
110 first capacity
111 first relief terminal
112 second relief terminal
200 first load
300 second load
400 first external power supply
500 second external power supply

What is claimed is:

1. A power supply system, comprising:
a first power supply line configured to supply a first load that is driven by power of a first voltage value with the power of the first voltage value;
a second power supply line configured to supply a second load that is driven by power of a second voltage value different from the first voltage value with the power of the second voltage value;
a power supply source configured to supply power of a third voltage value different from the first voltage value and the second voltage value;
a first power converter configured to convert the power of the third voltage value that is supplied by the power supply source to the power of the first voltage value to supply such first power to the first power supply line;
a second power converter configured to convert the power of the third voltage value that is supplied by the power supply source to the power of the second voltage value to supply such second power to the second power supply line;
a first battery configured to supply the power of the first voltage value to the first power supply line; and
a third power supply converter configured to convert the power of the first volage value that is supplied to the first power supply line to the power of the second voltage value to supply such power of the second voltage value to the second power supply line.

2. The power supply system according to claim 1,
wherein the power system is mounted in a vehicle, and further includes a control device configured to control initiation and stopping of the first power converter, the second power converter, and the third power converter,
the first load includes the control device, and
the control device is configured to:
during the vehicle is operating, control the first power converter and the second power converter to operate while controlling the third power converter to stop, and
during the vehicle is stopped, control the first power converter and the second power converter to stop while controlling the third power converter to operate.

3. The power supply system according to claim 2,
wherein the third power converter is configured to
operate when there is no stop instruction from a control signal form the control device, and
stop when there is the stop instruction from the control signal from the control device.

4. The power supply system according to claim 3, wherein driving power of the third power converter is supplied from the first power supply line and the second power supply line.

5. The power supply system according to claim 2,
wherein the control device is configured to
when an ignition power supply of the vehicle has been turned on from off, initiate the vehicle, the first power converter, and the second power converter, and
when the ignition power supply of the vehicle has been turned off from on, stop the vehicle, the first power converter, and the second power converter.

6. The power supply system according to claim 2, further comprises a first relay connected between the power supply source and a location between the first power converter and the second power converter,
wherein the control device is configured to,
when the vehicle is operating, control the first relay to be turned on to supply the power of the third voltage value from the power supply source to the first power converter and the second power converter, and
when the vehicle is stopped, control the first relay to be turned off to cut off the supply of the power of the third voltage value from the power supply source to the first power converter and the second power converter.

7. The power supply system according to claim 5,
wherein the control device is configured to
makes the first relay to be turned on when the ignition power supply of the vehicle is turned on from off, and
makes the first relay to be turned off when the ignition power supply of the vehicle is turned off from on.

8. The power supply system according to claim 1, further comprises a first relief terminal for connecting a first external power supply supplying the power of the first voltage value to the first power supply line.

9. The power supply system according to claim 1, further comprises a second relief terminal for connecting a second external power supply supplying the power of the second voltage value to the second power supply line,
wherein the third power converter is configured to convert the power of the second voltage value that is supplied to the second power supply line to the power of the first voltage value to supply to the first power supply line.

10. The power supply system according to claim 1, further comprises a first capacitor connected to the second power supply line.
